(19) United States
(12) Patent Application Publication
(10) Pub. No.: US 2006/0157089 A1
(43) Pub. Date: Jul. 20, 2006

(54) Automatic eyeglass cleaner

(76) Inventors: Charles E. Taylor, Punta Gorda, FL (US); Andrew J. Parker, Novato, CA (US); Edward C. McKinney JR., Novato, CA (US); Sik Leung Chan, San Francisco, CA (US); John S. Efroymson, Toledo, OH (US)

Correspondence Address: BELL, BOYD & LLOYD LLC, P.O. BOX 1135, CHICAGO, IL, 60690-1135, US

(21) Appl. No.: 11/286,566

(22) Filed: Nov. 22, 2005

Related U.S. Application Data
(63) Continuation-in-part of application No. 10/954,913, filed on Sep. 30, 2004.
Application No. 10/954,913 is a continuation of application No. 10/761,839, filed on Jan. 21, 2004, now Pat. No. 6,821,355.
(60) Provisional application No. 60/490,671, filed on Jul. 29, 2003.
(60) Provisional application No. 60/630,849, filed on Nov. 24, 2004.

(51) Int. Cl. B08B 3/00; B08B 3/12

(52) U.S. Cl. 134/52; 134/184

(57) ABSTRACT

An eyeglass cleaner can include a clip configured to hold a pair of eyeglasses, an agitator arm coupled to the clip, and a solution tank. The agitator arm can be configured to move the clip in a forward and backward motion during at least one of a cleaning operation or a drying operation. The clip can be configured to move between a lowered position in which the clip can be located within the solution tank and a raised position in which the clip can be located above the solution tank.

### PRIORITY CLAIM

This application is a continuation-in-part of and claims priority to U.S. patent application Ser. No. 10/954,913, filed Sep. 30, 2004, entitled “Automatic Eyewear Cleaner,” which is a continuation of U.S. patent application Ser. No 10/761,839, now U.S. Pat. No. 6,821,355, filed Jan. 21, 2004, entitled “Automatic Eyewear Cleaner,” which claims priority to U.S. Provisional Application No. 60/490,671, filed Jul. 29, 2003, entitled “Automatic Eyewear Cleaner,” and this application also claims priority to U.S. Provisional Application No. 60/630,849 entitled “Automatic Eyewear Cleaner,” filed Nov. 24, 2004, all of which are hereby incorporated by reference.

### TECHNICAL FIELD

This invention is related to automatic eyeglass cleaners.

### BACKGROUND

Whether they are for vision correction, vision protection or simply used as a fashion accessory, eyewear has long been a popular, if not indispensable, personal accessory. There are specialty eyewear which includes a wide range of eyeglasses and sunglasses that are designed for a specific purpose, such as computer use, driving, work, hobbies, eye protection and more. A huge variety of frames are available for prescription eyeglasses or sunglasses. Not only are there many different shapes and colors in eyeglass frames, but advances in technology have also brought a variety of new materials, for both the frames and the lens, which makes eyeglasses more durable, lightweight and comfortable. Eyeglass frames are now created from high-tech materials such as titanium and memory metals, while the lens are now thinner and lighter than ever before, even for high prescriptions. Lens coatings, including scratch-resistant coatings, ultraviolet treatments, anti-reflective coatings and mirror coatings, are commonly added to the lens to enhance their performance and appearance.

These high-tech frames and coated lens are expensive and are worth protecting. Unfortunately, the lens (even scratch-resistant coatings are not scratch proof) can easily be damaged by casual cleanings by the wearer, leaving the lens with a unsightly scratched surface that can hinder vision. As any eyewear user knows, eyewear can require cleaning with just a short time of wear. Because of the eyewear's close contact to the wearer, body oils, sweat, grime and dead skin cells gets trapped in the lens and frame and accumulate in little time. Dust, dirt and fingerprints on the lens add to this unwanted mess. Further, the metal finish of frames can corrode and become discolored from prolonged exposure to sweat, which is acidic in nature.

Wiping the eyewear with tissue paper or the corner of a shirt is a common practice for many eyeglass wearers. However, ordinary tissue paper and many types of cloths are highly abrasive because of their coarse fibers. Wiping the lens with these often lead to irreparable damage to the coating. Small, hard particles such as sand may also be deposited on the lens, and a simple wiping may be akin to polishing the lens with sandpaper.

Non-abrasive Micro-fiber Towels, with each strand of fiber being made of hundreds of micro-fibers (on the scale of 90,000 micro-fibers per sq. inch) have been gaining popularity in eyeglass care. These micro-fibers act to attract and hold dirt and grime, and can retain up to seven times its weight. The cloth used in micro-fiber towels is made of a matrix of polyester and polyamide weaved in such a way as to create a “clinginess” that picks up dirt. However, these towels are unable to reach tiny nooks and crannies of the eyeglass frame, and do not counteract the acidic corrosion of sweat. Further, because the cloths trap and hold grime, they get dirty very quickly and lose their effectiveness without frequent laundering.

Ultrasonic cleaners, such as the one taught in U.S. Pat. No. 4,114,194, have long been known in the field of professional jewelers and optometrists. The ability of a liquid when ultrasonically agitated to penetrate small spaces and, by cavitation, to remove foreign matter from solid objects has led to the wide use of ultrasonic cleaners in laboratories and industry. However, it is discovered that the use of ultrasonics tends to break down and remove the coating on the lens.

### SUMMARY

According to one embodiment, an eyeglass cleaner can include a clip configured to hold a pair of eyeglasses, an agitator arm coupled to the clip, and a solution tank. The agitator arm can be configured to move the clip and pair of eyeglasses in a forward and backward motion during at least one of a cleaning operation or a drying operation. The clip can be moved between a lowered position in which the clip can be located within the solution tank and a raised position in which the clip can be located above the solution tank.

According to another embodiment, an eyeglass cleaner can include a clip configured to hold a pair of eyeglasses, an agitator arm coupled to the clip, a first magnetic element of a first polarity coupled to the agitator arm, a second magnetic element of a second polarity opposite to the first polarity coupled to the clip, and a solution tank. The agitator arm can be configured to move the clip and attached pair of eyeglasses in a forward and backward motion during at least one of a cleaning operation or a drying operation. The clip can be moved between a lowered position in which the clip can be located within the solution tank and a raised position in which the clips can be located above the solution tank.

Additional features and advantages are described herein, and will be apparent from, the following Detailed Description and the figures.

### BRIEF DESCRIPTION OF THE FIGURES

FIG. 1 shows a perspective view of an embodiment of an automatic eyeglass cleaner in a closed position.

FIG. 2 shows a perspective view of an embodiment of the cleaner in an open position, including a pair of eyeglasses.

FIG. 3 shows a perspective view of an embodiment of the cleaner, including a cover.

FIGS. 4A and 4B show side perspective views of an embodiment of a clip for holding a pair of eyeglasses in a closed position (FIG. 4A) and an open position (FIG. 4B).

FIG. 5 shows a perspective view of an embodiment of an agitator arm configured to be coupled to clip of FIGS. 4A and 4B.

FIGS. 6A and 6B show side perspective views of another embodiment of a clip for holding a pair of eyeglasses in a closed position (FIG. 6A) and an open position (FIG. 6B).

FIG. 7 shows a perspective view of another embodiment of an agitator arm configured to be coupled to the clip of FIGS. 6A and 6B.

FIG. 8 shows a perspective view of an embodiment of the cleaner in which the solution tank has been removed.

FIG. 9 shows a cut-away perspective view of an embodiment of a rear portion of the cleaner.

FIG. 10 shows a perspective of an embodiment of the internal components of the cleaner.

FIG. 11 shows a cross-section view of an embodiment taken along line A-A in FIG. 1.

### DETAILED DESCRIPTION

According to one embodiment, an automatic eyeglass cleaner is provided. A specially formulated cleaning and conditioning solution is also provided for use with the automatic cleaner. A solution tank in the automatic cleaner can be filled with the cleaning and conditioning solution. A pair of eyeglasses can be folded up and clipped to the bottom of an open lid of the cleaner. The lid can then be closed to lower the pair of eyeglasses into the cleaning and conditioning solution in the solution tank. A cleaning operation can begin by actuating a button, for example, and the pair of eyeglasses can be moved in a forward and backward motion or agitated in the cleaning and conditioning solution. The cleaning operation can stop automatically after a pre-set time. After the cleaning operation stop, the lid of the cleaner can move to an open position excess solution can be shaken off the pair of eyeglasses during a drying operation. A thin film may be left on the lens. A microfiber cloth can be used to give the lens a touch-up and to polish the lens, thereby helping to fill in microscopic scratches on the lens. The entire process from start to finish (including the cleaning and drying operations) can last approximately one minute.

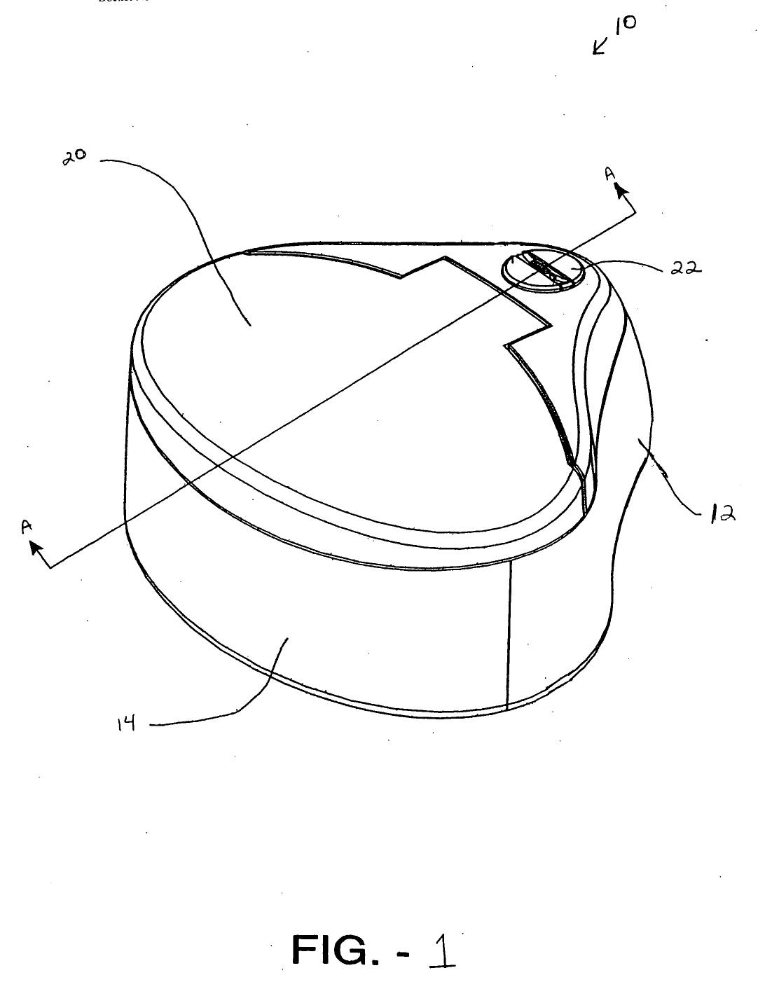

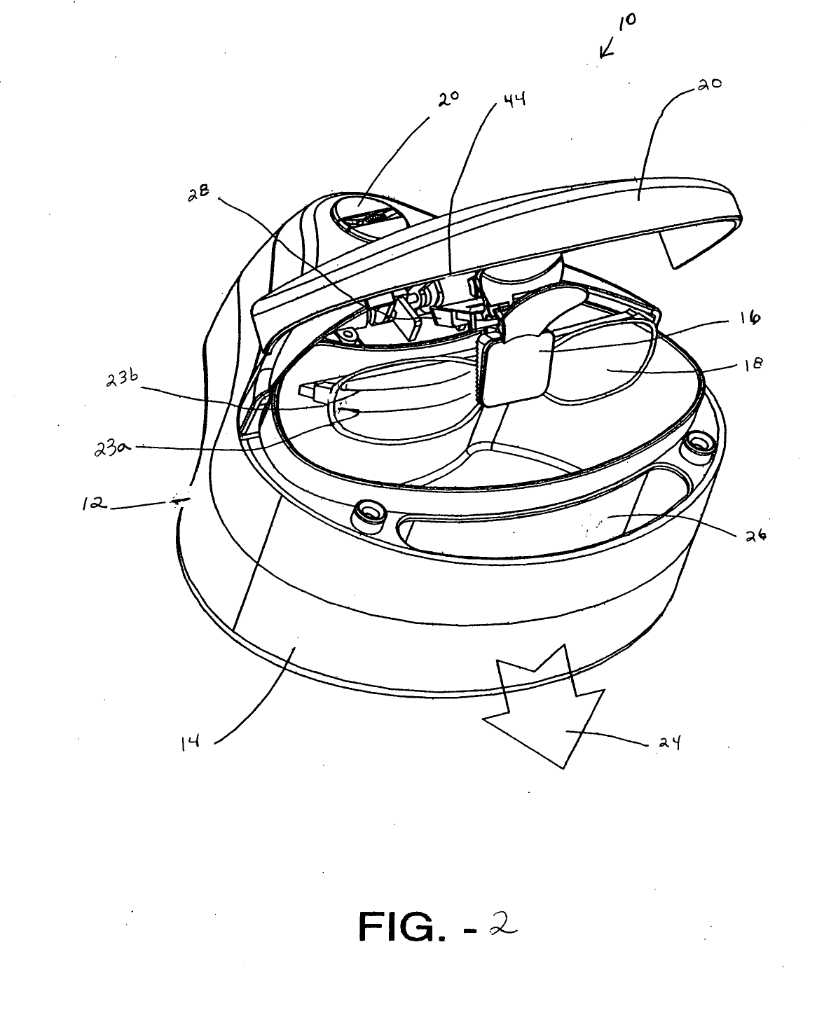

Referring to FIGS. 1 and 2, perspective views of one embodiment of an automatic eyewear cleaner 10 are shown. The cleaner 10 can include a housing 12, a solution tank 14, a holder or clip 16 for holding a pair of eyeglasses 18 (FIG. 2), and a lid 20.

As shown, the housing 12 can have a generally oval shape in one embodiment. Alternatively, the housing 12 can have other desired shapes such as, for example, a circular shape, a rectangular shape, a square shape, and the like. The housing 12 can be configured to house the electronics and motor for the cleaner 10, and can have operating controls 22 located thereon. The controls 22, which can be in the form of buttons as shown in FIGS. 1 and 2, can be configured to turn the cleaner 10 on and off as well as open and close the lid 20.

The solution tank 14 can be filled with a cleaning and conditioning solution. As shown in FIG. 2, fill lines 23a, b on the solution tank 14 can show a recommended minimum fill level 23a and recommended maximum fill level 23b. The minimum fill level 23a can be set to correspond to the minimum amount of cleaning and conditioning solution required to cover the pair of eyeglasses 18 entirely when the lid 20 is closed to lower the pair of eyeglasses 18 into the solution tank 14. The maximum fill level 23b can be set to correspond to the maximum amount of cleaning and conditioning solution allowed to avoid spillage and splattering when the cleaner 10 is in operation and when the solution tank 14 is removed from the cleaner 10 for cleaning and disposal of used cleaning solution, for example. As shown in FIG. 2, the solution tank 14 can be removed from the cleaner 10 by sliding the solution tank 14 in the direction of arrow 24. Additionally, the solution tank 14 can include a storage compartment 26 that can be made integral with the solution tank 14.

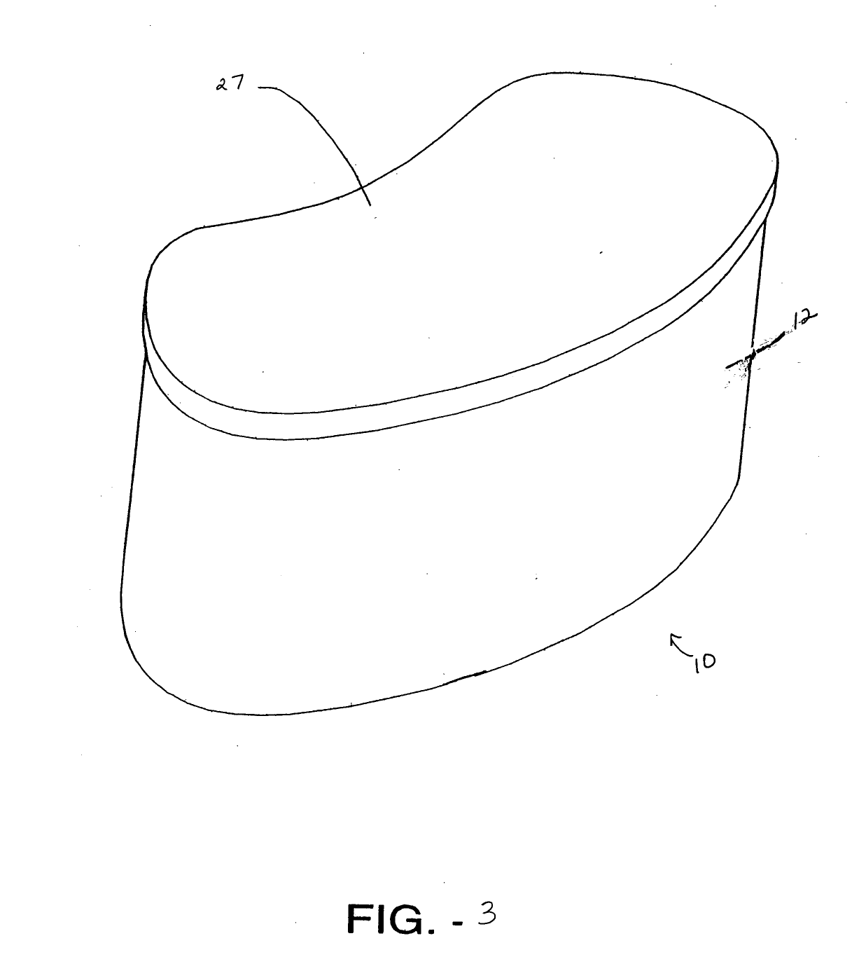

Referring to FIG. 3, the cleaner 10 can further include a cover 27 configured to seal the solution tank 14 to prevent or reduce the cleaning and conditioning solution from leaking or spilling from the solution tank 14 when the cleaner 10 is moved.

The lid 20 can be configured to move between a closed position (shown in FIG. 1) and an open position (shown in FIG. 2). In one embodiment, the lid 20 can pivot between the closed and the open position. Alternatively, the lid 20 can slide from the closed position to the open position if desired. In the open position, the lid 20 can be located at an angle that is sufficient for attachment and detachment of the clip 16 and pair of eyeglasses 18 when the solution tank 14 is filled and attached to the cleaner 10. In one embodiment, the lid 20 can be configured to remain open, even when the full weight of the clip 16 and eyeglasses 18 is attached to it, until the lid 20 is closed by, for example, a user pressing down on the lid 20. Additionally, the lid 20 can be configured to open and raise the pair of eyeglasses 18 above the cleaning and conditioning solution in the solution tank 14 until, for example, a user retrieves them.

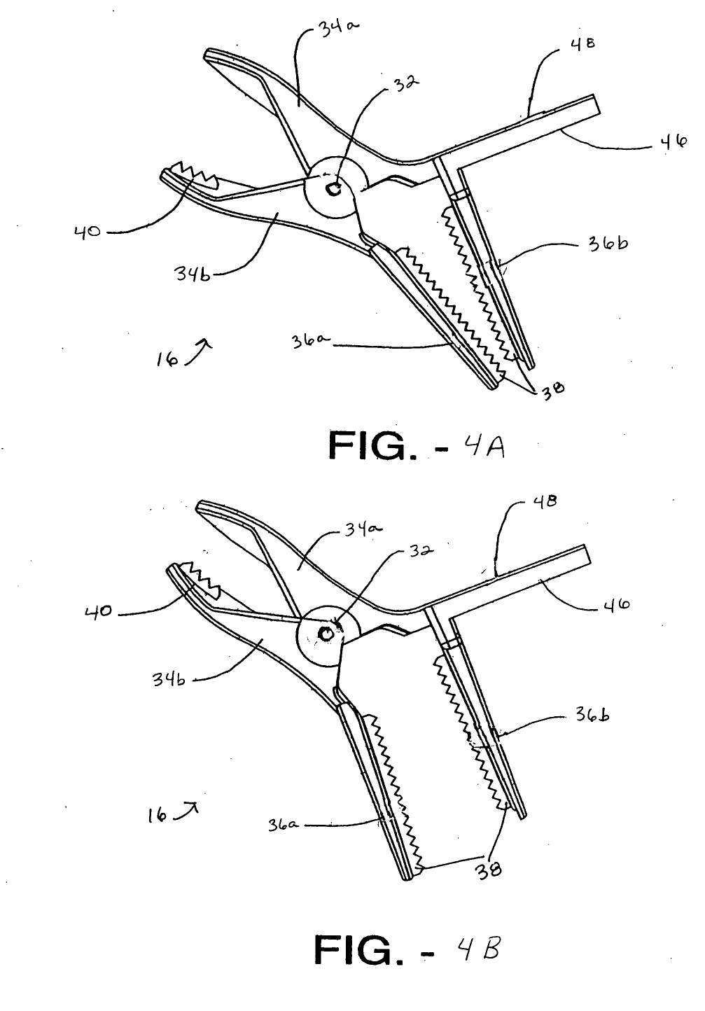

Referring to FIGS. 4A-4B, an embodiment of the clip 16 for holding a pair of eyeglasses 18 is shown. With particular reference to FIGS. 4A and 4B, one embodiment of the clip 16 is shown in a closed position (FIG. 4A) and an open position (FIG. 4B). As shown, the clip 16 can include a spring 32, a first handle member 34a, a second handle member 34b, an upper retention member 36a, a lower retention member 36b, and a plurality of toothlike projections 38 located on one or both of the upper and lower retention members 36a,b.

The spring 32 can be configured to bias the clip 16 in the closed position. The clip 16 can be configured to move to the open position upon actuation of one or both of the first and second handle members 34a, b. Specifically, the clip 15 can be configured to move from the closed position to the open position when sufficient pressure is applied to one or both of the first handle member 34a or the second handle member 34b. When the clip 16 is in the open position, the clip 16 can receive a pair of eyeglasses 18 by positioning the upper and lower retention members 36a,b of the clip 16 over a nose bridge of a folder pair of eyeglasses 18, for example. When pressure on the first and second handle members 34a,b is removed, the clip 16 can be configured to move toward the closed position to hold the pair of eyeglasses 18 between the upper and lower retention members 36a,b. In one embodiment, the pair of eyeglasses 18 is configured to engage the plurality of toothlike projections 38 which can be, for example, rubber protrusions located on one or both of the upper retention member 36a or the lower retention member 36b, when the pair of eyeglasses 18 is held between the upper and lower retention members 36a,b.

In one embodiment, the clip 16 can include a finger grip area 40 on the second handle member 34b, for example. The finger grip area 40 can facilitate quick loading and unloading of the clip 16 into the cleaner 10 by actuating the second handle member 34b only such that the clip 16 is not moved entirely to the open position.

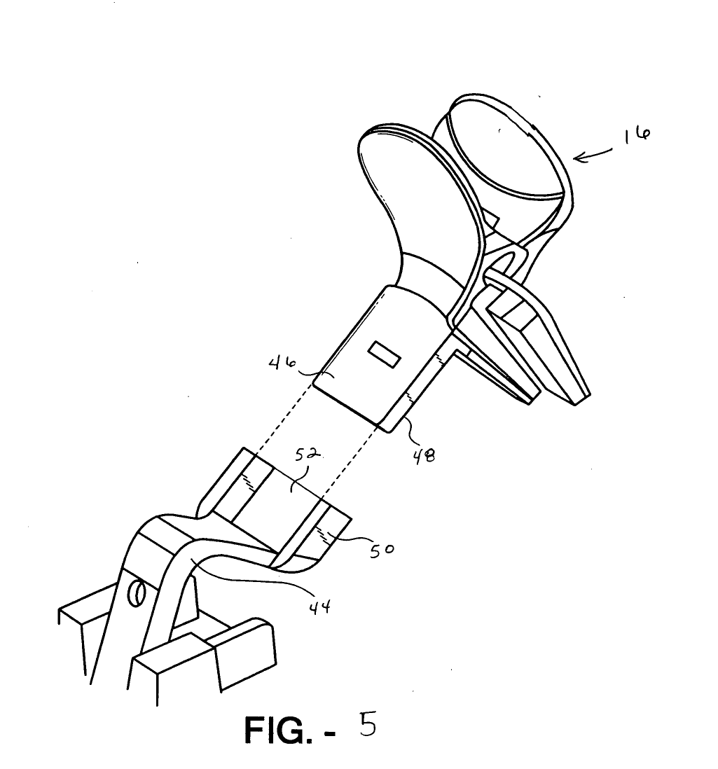

Referring to FIG. 5, in one embodiment, the clip 16 can be removably attached to a receptacle 50 on an agitator arm 44. As shown, the clip 16 can include an attachment part 46 that extends from the clip 16. A first magnetic element 48 such as, for example, a metal piece, can be coupled to the attachment part 46. In one embodiment, the attachment part 46 itself can be a piece of metal with the first magnetic element 48 coupled to a lower surface of the attachment part 46.

As shown in the embodiment of FIG. 5, one end of the agitator arm 44 can include a receptacle 50 configured to engage or receive the attachment part 46 of the clip 16. A second magnetic element 52 such as, for example, a metal piece, can be located on an upper surface of the receptacle 50. In one embodiment, the second magnetic element 52 can have a polarity that is opposite to the polarity of the first magnetic element 48. As a result, when the attachment part 46 of the clip 16 having the first magnetic element 48 is brought into proximity with the receptacle 50 of the agitator arm 44 having the opposite polarity second magnetic element 52, the first and second magnetic elements 48, 52 can be attracted to each other to cause the clip 16 to be coupled to the agitator arm 44. In one embodiment, the receptacle 50 can have a shape that is complementary with the shape of the attachment part 46 to ensure a secure fit. Additionally, the first magnetic element 48 and the second magnetic element 52 can be configured to have sufficient strength to ensure that the clip 16 remains coupled to the end of the agitator arm 46 when the clip 16 is coupled to a pair of eyeglasses 18 throughout the cleaning and drying operations while still allowing the clip 16 to be easily removed or detached from the end of the agitator arm 44 by, for example, pulling the clip 16 from the agitator arm 44.

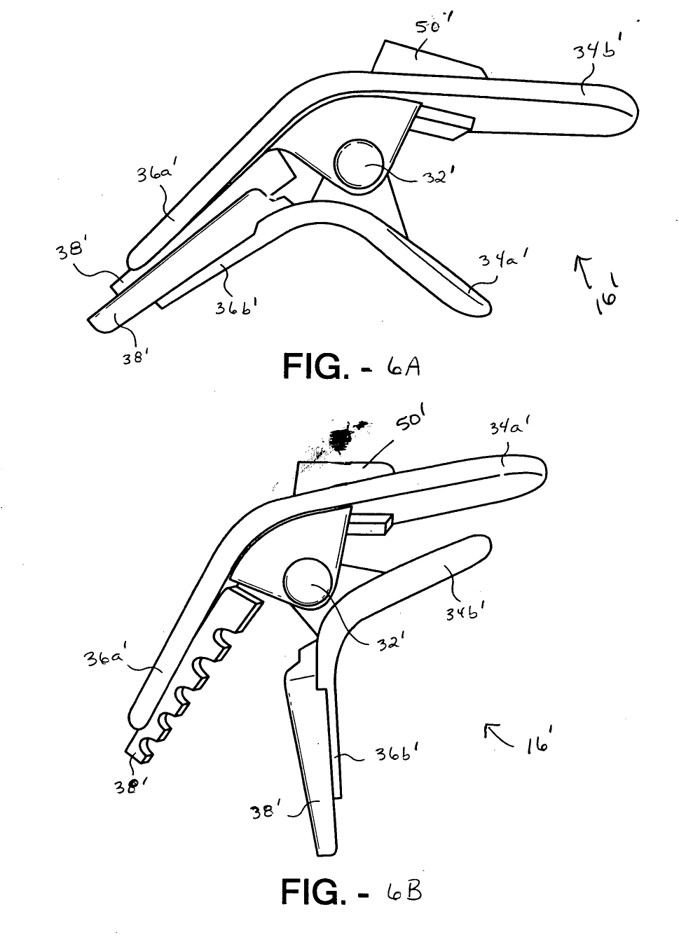

Referring to FIGS. 6A-6B, an alternative embodiment of the clip 16′ is shown in the closed position (FIG. 6A) and the open position (FIG. 6B). As shown, one or more of the upper and lower retention members 36a′, 36b′ can include a plurality of projections 38′ having a different configuration than the toothlike projections 38 shown in FIGS. 4A and 4B. For example, the plurality of projections 38′ can include generally flat surfaces separated by u-shaped portions (instead of generally pointed surfaces separated by v-shaped portions shown in FIGS. 4A and 4B). Additionally, the clip 16′ shown in FIGS. 6A and 6B can be moved between the closed position and the open position by actuating only one of the handle members 34a′, 34b′ such as, for example, the second handle member 34b′, instead of actuating both handle members 34a,b.

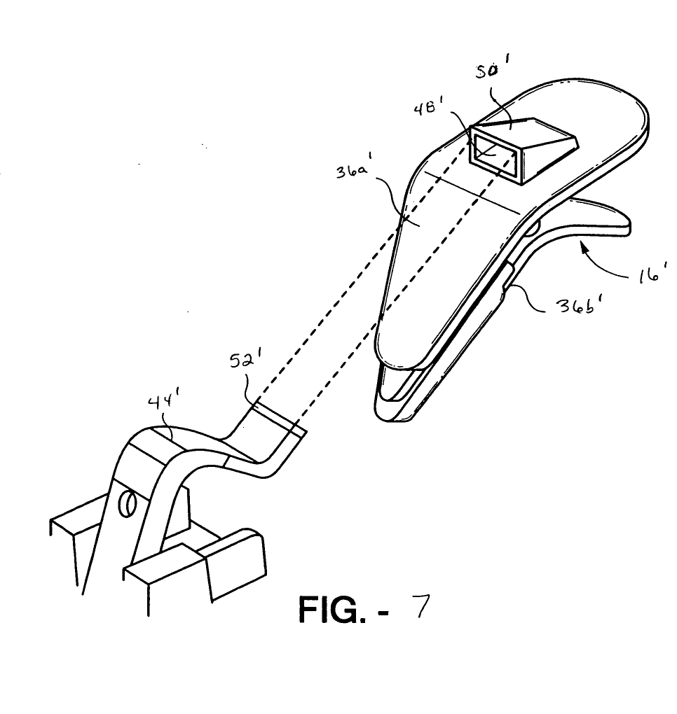

Referring to FIG. 7, the receptacle 50′ can be located at the upper retention member 36a′ of the clip 16′ (instead of being associated with the agitator arm 44 as shown in FIG. 5) and can be configured to receive and substantially surround one end of the agitator arm 44′ therein when the clip 16′ is coupled to the agitator arm 44′. In this embodiment, the first magnetic element 48′ having a first polarity (e.g., a metal piece) can be located within the receptacle 50′ of the clip 16′, and the second magnetic element 52′ (e.g., a metal piece) having a second polarity opposite the first polarity can be coupled to one end of the agitator arm 44′. As a result, when the end of the agitator arm 44′ having the second magnetic element 52′ is inserted into the receptacle 50′ of the clip 16′ having the opposite polarity second magnetic element 52′ therein, the first and second magnetic elements 48′, 52′ can be attracted to each other to cause the clip 16′ to be coupled to the agitator arm 44′. Similar to the embodiment of FIG. 5, the receptacle 50′ of FIGS. 6A, 6B, and 7 can have dimensions that are complementary to the dimensions of the end of the agitator arm 44′ to ensure a secure fit. Additionally, the first magnetic element 48′ and the second magnetic element 52′ can be configured to have sufficient strength to ensure that the clip 16′ remains coupled to the end of the agitator arm 46′ when the clip 16′ is coupled to a pair of eyeglasses throughout the cleaning and drying operations while still allowing the clip 16′ to be easily removed or detached from the end of the agitator arm 44′ by, for example, pulling the clip 16′ from the agitator arm 44′.

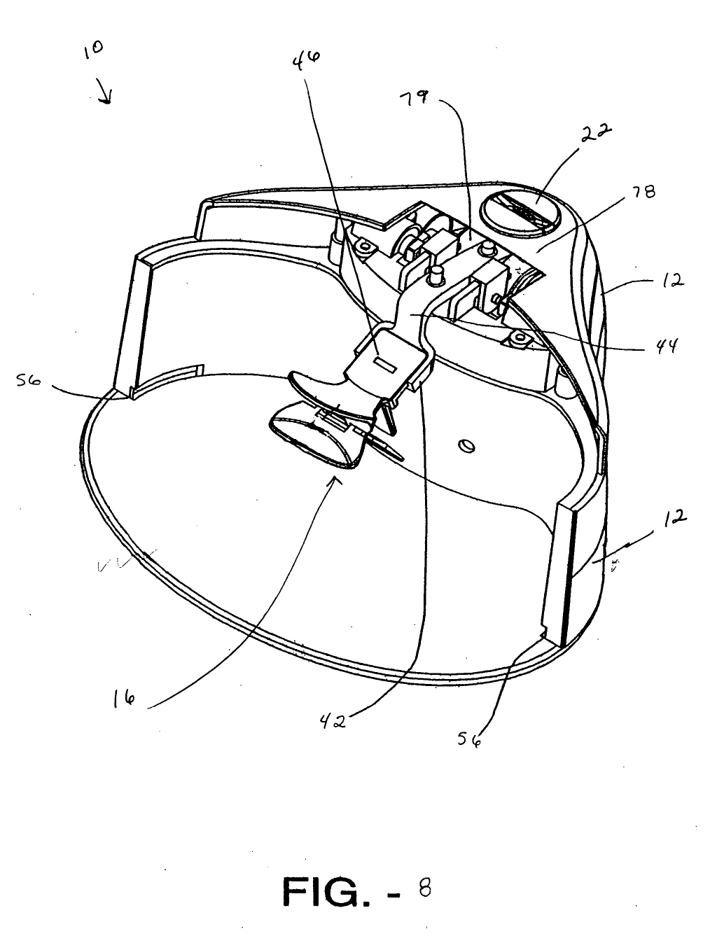

Referring to FIG. 8, a front view of one embodiment of the cleaner 10 is shown with the solution tank 14 and the cleaner lid removed. The solution tank 14 can be inserted into and removed from the cleaner 19 via slots 56 located on the housing 12 of the cleaner 10. The slots 56 can be configured to slide into mating portions of the solution tank 14 to ensure that the solution tank 14 can be properly seated within the cleaner 10 once installed. The clip 16 in this embodiment can be magnetically coupled to the receptacle 50 located at the end of the agitator arm 44. In this embodiment, the receptacle 50 can be integral with one end of the agitator arm 44, and the other end of the agitator arm 44 can extend into the housing 12 of the cleaner 10.

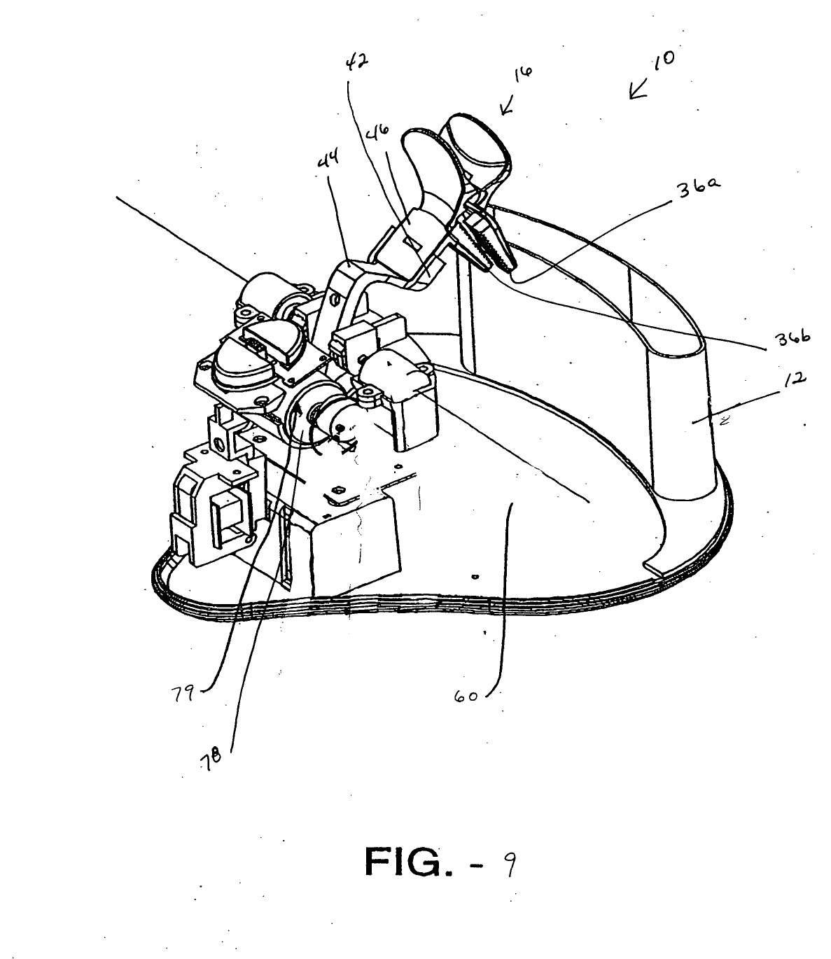

Referring to FIG. 9, a cut-away view of one embodiment of the housing 12 of the cleaner 10 is shown from the back. In this embodiment, the agitator arm 44 is shown aligned but not connected to the lid 20, with both being pivotally mounted along a common axis, 51. The agitator arm 44 can be configured to be separate from the lid 20 such that when the lid 20 is closed and the agitator arm 44 is actuated to agitate or move the pair of eyeglasses 18 in the cleaning and conditioning solution in the solution tank 14, the vibrations passing directly to the lid 20 can be minimized. The cleaner 10 can, thus, remain relatively stable on a flat surface during operation because the vibrations from the agitation or movement of the pair of eyeglasses 18 can be kept internal to the cleaner 10.

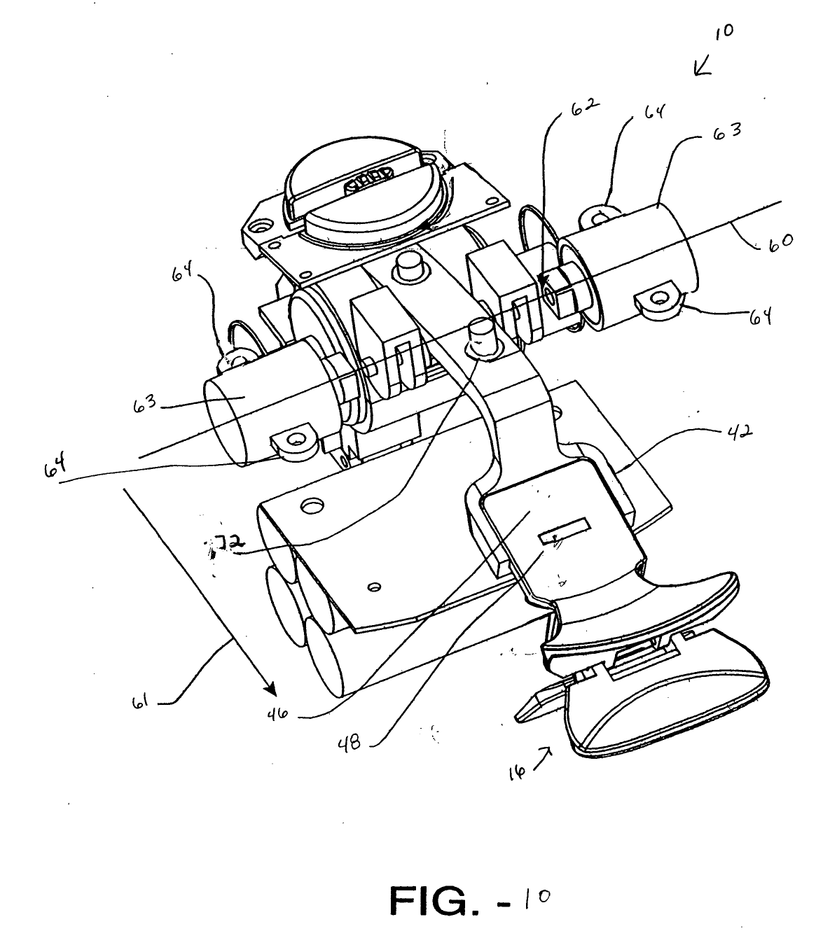

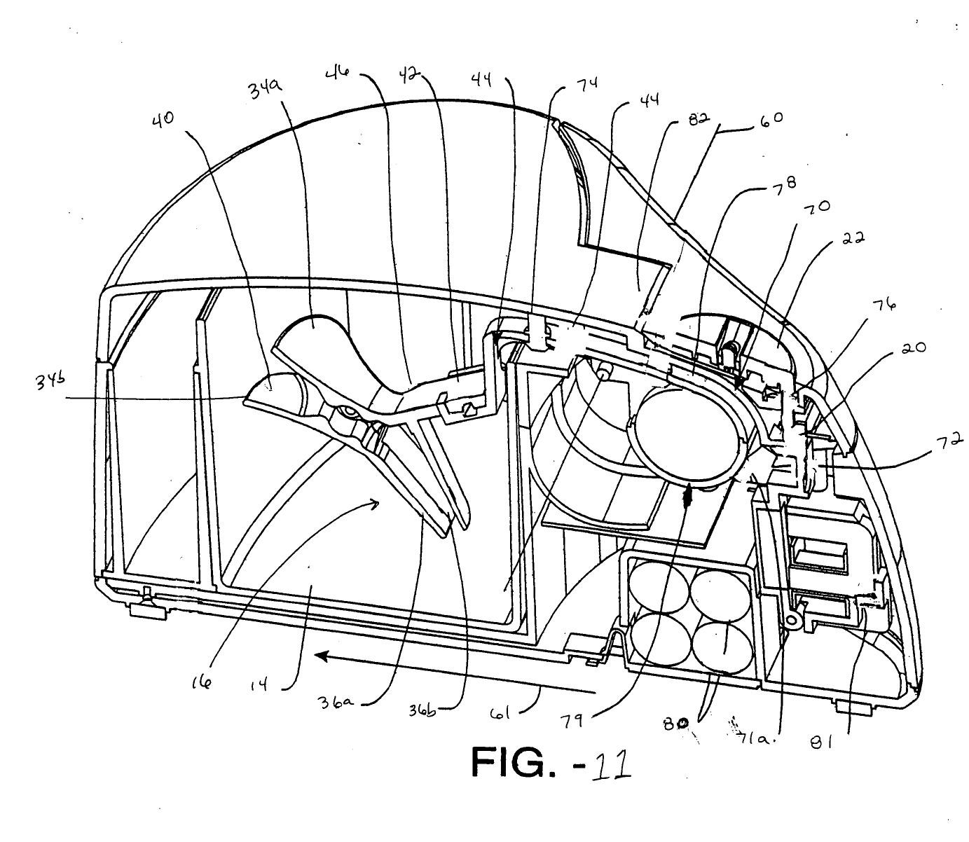

Referring to FIG. 10, the internal components of the cleaner 10 are shown. FIG. 11 shows a cross-section of the cleaner 10 taken along line A-A of FIG. 1. The direction arrow 61 in FIGS. 10 and 11 designates the front of the cleaner 10. With particular reference to FIG. 10, the lid 20 can be pivotally mounted at 62 on at least two damper torsional springs 63, wherein the torsional springs 63 can be secured with screws 64 onto the cleaner housing 12 along axis 60. The torsional springs 63 can exert tension to hold the lid 20 in its open position. A part of the lid 20 aft of the axis 60 can extend inside the housing 12 and can form a curved surface 70 of the lid 20, which can slope downwards. The lid 20 can pivot about axis 60 as the lid 20 is raised and lowered, and the curved surface 70 can move in an opposite relationship to the front of the lid 20.

With particular reference to FIG. 11, when the front of the lid 20 is pushed down to close the lid 20, the curved surface 70 can pivot upwards, and its end can click onto a spring-loaded catch 72 such that the lid 20 can be held in the closed position. A raised rubber divot 74 on the agitator arm 44, which can be mounted forward of axis 60, can push down on the agitator arm 44 as the lid 20 is closed and can lower the clip 16 and the pair of eyeglasses (not shown) into the solution tank 14. An operating control 22 (e.g., a button 22), which can be depressed to open the lid 20, can be integral with a push-rod 76 that can extend downward and can come in contact with the catch 72. Depressing the button 22 can cause the rod 76 to be pushed down, which can release the catch 72 and which can allow the curved surface 70 to pivot downward (from the tension exerted by the damper torsional springs 63, for example).

Thus, the front of the lid 20 can be raised. As the lid 20 opens, it can exert pressure on the raised rubber divot 74 on the agitator arm 44 located forward of the axis 60, and can raise the agitator arm 44 to lift the pair of eyeglasses out of the cleaning and conditioning solution in the solution tank 14. To eliminate or reduce splatter as the pair of eyeglasses is lifted, the damper torsional springs 63 can be immersed in thick viscosity lubrication so that the lid 20 can open gradually.

As shown, the agitator arm 44 can be operably coupled to a motor 78 located within a motor housing 79 to move the clip 16 and pair of eyeglasses 18. As shown, the motor 78 can be located aft of axis 60. In one embodiment, The motor 78 can remain integral with the agitator arm 44 when the agitator arm 44 is raised and lowered.

In one embodiment, the motor 78 can be powered by common DC batteries 80, which can be inserted into the cleaner housing 12 through a door located on the bottom of the housing 12. The motor 78 can rotate about a shaft that can extend out of the sides of the motor 78. Weights can be mounted at each side of the motor 78. When the motor 78 is turned on, strong, rhythmic vibrations can be produced due to the weights rotating off-center at high speeds. The vibrations can be transferred directly through the motor housing 79 to the agitator arm 44 and the receptacle 50. Accordingly, the vibrations can also be transferred to the clip 16 and pair of eyeglasses 18 when the pair of eyeglasses 18 is coupled to the clip 16.

In one embodiment, the motor 78 can operate at approximately 1300 rpm, which can be sufficient to move the agitator arm 44 in a forward and backward motion to produce agitation during a cleaning operation when the pair of eyeglasses 18 is located in the cleaning and conditioning solution in the solution tank 14. The speed of the motor 78 can also be sufficient move the agitator arm 44 in a forward and backward motion to shake the pair of eyeglasses 18 substantially dry during a drying operation when the pair of eyeglasses 18 is raised above the cleaning and conditioning solution in the solution tank 14. Although the agitator arm 44 has been described as moving in a forward and backward motion during the cleaning and drying operations, it is to be understood that the agitator arm 44 can move in any desired manner during the cleaning and drying operations. For example, the agitator arm 44 can move in an up and down motion, a side to side motion, a circular motion, and the like. In one embodiment, the motor 78 can continue to operate uninterrupted at the same speed during the cleaning and drying operations, with the only difference being whether the end of the agitator arm 44 is lowered within the solution tank 14 during a cleaning operation or raised above the solution tank 14 during a drying operation.

When the lid 20 is closed, the pair of eyeglasses 18 can be lowered into the cleaning and conditioning solution in the solution tank 14. A user can then actuate the operating controls 22 such as, for example by pressing button 22, to begin the automatic cleaning operation. Actuating the operating controls 22 can activate electronic timing circuitry to turn on the motor 78. In an alternative embodiment, a mechanical or electromechanical timer can also be used. During the cleaning operation, the motor 78 can operate for a preset amount of time to agitate the pair of eyeglasses 18 in the cleaning and conditioning solution in the solution tank 14. In one embodiment, the cleaning operation can last for approximately 40-50 seconds, which can be sufficient time for the cleaning and condition solution to substantially dissolve and/or remove the dirt and/or grime from the pair of eyeglasses 18.

At the expiration of the preset amount of time for the cleaning operation, the timing circuit can begin the drying operation and can trigger an electromagnet 81 located in the housing 12, which can attract a metal piece integral with the releasable catch 72. This can pull the catch 72 toward the electromagnet 81 and can release the curved end 70 of the lid 20. As a result, the front of the lid 20 can be raised due to the tension exerted by the torsion springs 63.

When the lid 20 is opened, the agitator arm 44 (including the clip 16 with the pair of eyeglasses 18 attached to it) can be raised above the cleaning and conditioning solution in the solution tank 14. The lid 20 can pivot about the axis 60 until the front of the lid 20 engages or abuts edge 82 such that the lid 20 can remain in a fully open position and the pair of eyeglasses 18 can be held above the solution tank 14. The agitator arm 44 can continue to vibrate while in the raised position to shake the wet pair of eyeglasses 18 substantially dry. Cleaning and conditioning solution from the wet pair of eyeglasses 18 can be collected in the solution tank 14 and can be re-used in future cleanings. In one embodiment, the drying operation can last approximately 10-20 seconds, after which the timing circuit can turn the motor 78 off. As discussed above, the motor can remain running uninterrupted from the beginning of the cleaning operation to the end of the drying operation in one embodiment.

In one embodiment, the electronic timing circuitry can also control the timing of LCD or LED lights, which can be located in the housing 12 behind the solution tank 14 and can shine through the cleaning and conditioning solution to create a light show. In this embodiment, the cleaner 10 can be made of a transparent or translucent material to allow the light to shine through.

In one embodiment, the novel cleaning and conditioning solution for use with the automatic eyeglass cleaner 10 can include deionized water, Berol 226, Triethanolamine 99, Hydroxymethylglycinate, Isopropyl Alcohol, Sorbitan Mono-oleate, acid blue 9 and Polydimethylsiloxane Emulsion. Table 1 lists the percentage by weight of each ingredient in one embodiment.

TABLE I

| INGREDIENT | PERCENT W/W |
|---|---|
| Deionized Water | 61.4 |
| Berol 226 (Akzo Nobel) | 7.5 |
| Triethanolamine 99 | 10.5 |
| Hydroxymethylglycinate | 3 |
| Isopropyl Alcohol | 2.5 |
| Sorbitan Mono-oleate | 5 |
| 1% Acid Blue 9 | 0.1 |
| Polydimethylsiloxane Emulsion | 10 |

Berol SA is a blend of a nonionic and cationic surfactant that can be optimized for use in water-based degreasing cleaners. It can be efficient for cleaning organic soils such as, for example, grease and oil. Triethanolamine 99% can be formed from the reaction of ethylene oxide and ammonia. It can be miscible with water and alcohol and can make the cleaning and conditioning solution alkaline, with improved grease removal and compatibility among the ingredients. A biocide, the aqueous solution of Sodium Hydroxymethylglycinate, can be derived from Glycine, which is a naturally occurring amino acid. It can have broad pectrum antimicrobial activity and can be effective against bacteria and fungi. Isopropyl Alcohol, also known as IPA, 2-propanol and isopropanol, is a colorless clear liquid with a pleasant odor. It can be a good dehydrating agent and disinfectant. Sorbitan Mono-oleate is a light amber-color surfactant that can be used as an nonionic lipophilic surface active agent. It can be an emulsion stabilizer. The aqueous emulsion of polydimethylsiloxane can be an anti-fogging agent and can give the pair of eyeglasses 18 a slick feel. It can be relatively inert, can be easy to dilute and disperse, and can be effective over a wide range of temperatures and pH conditions. Acid Blue 9, also known as Brilliant Blue FCF, C.I. Acid Blue 9, diammonium salt, C.I. Acid Blue 9, and disodium salt, is a widely used food dye. It can be a reddish-violet powder or granules with metallic luster.

In one embodiment, the cleaning and conditioning solution can be manufactured by adding the above ingredients in the following order: deionized water, Berol 226, Triethanolamine 99, Hydroxymethylglycinate, Isopropyl Alcohol, Sorbitan Mono-oleate. The mixture can be mixed until all the ingredients are dissolved and uniform. Next, 1% Acid Blue 9 can be added to the solution and mixed. Polydimethylsiloxane emulsion can then be added and the solution can continue to be mixed. In one embodiment, the solution can be mixed for at least approximately fifteen minutes to obtain the final solution in concentrate form having a pH of approximately 9.2-10.2 and a specific gravity of approximately 1.018-1.024 (gm/ml). The concentrate can be diluted to approximately 1:32 with ordinary tap water to obtain a cleaning and conditioning solution for use in the cleaner 10.

In one embodiment, the cleaning and conditioning solution can have the ability to emulsify and dissolve body oils, dirt and grime deposited on the pair of eyeglasses 18. Further, the cleaning and conditioning solution can form a thin film on surfaces it comes into contact with such as, for example, the lens of the pair of eyeglasses 18. This film can fill in micro-cracks and scratches on the surface of the lens and coating, and can help to restore the surface of the lens.

After the drying operation is complete, the clean pair of eyeglasses 18 may be substantially dry and a thin film of silicone may be deposited on the lens. A user can then reach into the open lid 20 and grab the clip 16. Pulling the clip 16 can disengage the magnet(s) coupling the clip 26 to the agitator arm 44. As a result, the clip 16 with the attached pair of eyeglasses 18 can be removed from the cleaner 10.

The handle members 34a,b of the clip 16 can be actuated to release the pair of eyeglasses 18 from the upper and lower retention members 36a,b. A micro-fiber cloth can then be used to polish and dry the pair of eyeglasses 28. This touch-up can help the silicon fill in microscopic scratches on the lens. The clean pair of eyeglasses 18 can now be worn by the user.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An automatic eyeglass cleaner comprising:
a clip configured to hold a pair of eyeglasses;
an agitator arm coupled to the clip and configured to move the clip in a forward and backward motion during at least one of a cleaning operation or a drying operation; and
a solution tank, wherein the clip is configured to move between a lowered position in which the clip is located within the solution tank and a raised position in which the clip is located above the solution tank.

2. The eyeglass cleaner of claim 1, wherein the clip is movable between an open position to receive the pair of eyeglasses and a closed position to hold the pair of eyeglasses.

3. The eyeglass cleaner of claim 2, wherein the clip is biased in the closed position via a spring.

4. The eyeglass cleaner of claim 3, wherein the clip comprises a handle in communication with the spring, wherein the clip is movable from the closed position toward the open position upon actuation of the handle.

5. The eyeglass cleaner of claim 4, wherein the handle comprises a first handle member and a second handle member, wherein the clip is movable from the closed position toward the open position by urging the first handle member toward the second handle member.

6. The eyeglass cleaner of claim 5, wherein the clip is movable from the closed position toward the open position upon actuation of the first handle member.

7. The eyeglass cleaner of claim 2, wherein the clip comprises an upper retention member and a lower retention member, wherein the clip is configured to hold the pair of eyeglasses between the upper and lower retention members in the closed position.

8. The eyeglass cleaner of claim 7, wherein at least one of the upper retention member or the lower retention member comprises a plurality of projections, wherein the pair of eyeglasses engages the plurality of projections when the pair of eyeglasses is held by the clip.

9. The eyeglass cleaner of claim 1, further comprising a receptacle configured to engage one of the agitator arm or the clip to couple the clip to the agitator arm.

10. The eyeglass cleaner of claim 1, further comprising a magnetic element coupled to the agitator arm, wherein the clip is magnetically coupled to the agitator arm via the magnetic element.

11. The eyeglass cleaner of claim 1, further comprising a first magnetic element of a first polarity coupled to the agitator arm and a second magnetic element of a second polarity opposite the first polarity coupled to the clip, wherein the clip is magnetically coupled to the agitator arm via the first and second magnetic elements.

12. The eyeglass cleaner of claim 1, further comprising a lid coupled to the solution tank, wherein the lid is configured to move between an open position in which the solution tank is uncovered and a closed position in which the solution tank is covered by the lid.

13. The eyeglass cleaner of claim 12, wherein the clip is coupled to a bottom portion of the lid and movable with the lid, wherein the clip is in the lowered position when the lid is in the closed position, and wherein the clip is in the raised position when the lid is in the open position.

14. The eyeglass cleaner of claim 12, wherein the lid is configured to pivot between the open position and the closed position.

15. The eyeglass cleaner of claim 12, further comprising a cover located at an upper portion of the lid and configured to seal the solution tank.

16. The eyeglass cleaner of claim 1, wherein the solution tank comprises a storage compartment.

17. The eyeglass cleaner of claim 1, wherein the solution tank is removable from a housing of the eyeglass cleaner.

18. An eyeglass cleaner comprising:
a clip configured to hold a pair of eyeglasses;
an agitator arm coupled to the clip and configured to move the clip in a forward and backward motion during at least one of a cleaning operation or a drying operation;
a first magnetic element of a first polarity coupled to the agitator arm;
a second magnetic element of a second polarity opposite to the first polarity coupled to the clip, wherein the clip is magnetically coupled to the agitator arm via the first and second magnetic elements; and
a solution tank, wherein the clip is configured to move between a lowered position in which the clip is located within the solution tank and a raised position in which the clip is located above the solution tank.

19. The eyeglass cleaner of claim 18, further comprising:
a lid coupled to the solution tank and configured to move between a closed position in which the solution tank is covered by the lid and an open position in which the solution tank is uncovered,
wherein the clip is coupled to a bottom portion of the lid and is movable with the lid,
wherein the clip is in the lowered position when the lid is in the closed position, and
wherein the clip is in the raised position when the lid is in the open position.

20. The eyeglass cleaner of claim 19, wherein the clip comprises:
an upper retention member;
a lower retention member; and
a plurality of projections located on at least one of the upper retention member or the lower retention member, wherein the clip is configured to hold the pair of eyeglasses between the upper and lower retention members in the closed position, and wherein the clip is configured to hold the pair of eyeglasses between the plurality of projections in the closed position.
